(19) United States
(12) Patent Application Publication
(10) Pub. No.: US 2009/0266198 A1
(43) Pub. Date: Oct. 29, 2009

(54) LASER WELDED DIFFERENTIAL CASINGS FOR VEHICLE AXLES

(75) Inventor: Brian M. Nosakowski, Macomb, MI (US)

Correspondence Address: BROOKS KUSHMAN P.C., 1000 TOWN CENTER, TWENTY-SECOND FLOOR, SOUTHFIELD, MI, 48075, US

(73) Assignee: TRANSFORM AUTOMOTIVE LLC, Sterling Heights, MI (US)

(21) Appl. No.: 12/428,621

(22) Filed: Apr. 23, 2009

Related U.S. Application Data
(60) Provisional application No. 61/048,683, filed on Apr. 29, 2008.

(51) Int. Cl. F16H 57/02

(52) U.S. Cl. 74/606 R

(57) ABSTRACT

Different embodiments of a vehicle differential casing assembly (22a, 22b and 23c) have first and second casing halves laser welded to each other to mount and secure an associated annular ring gear (28a, 28b, 28c).

### CROSS-REFERENCE TO RELATED APPLICATIONS

This application claims the benefit of U.S. provisional application Ser. No. 61/048,683 filed Apr. 29, 2008.

### BACKGROUND OF THE INVENTION

1. Field of the Invention

This invention relates to vehicle axle differential casing assemblies.

2. Background Art

Vehicle axles conventionally include differential gearing supported within a differential casing for use with a differential housing of a vehicle axle to permit associated wheels to move at different rates such as when negotiating a turn in the direction of travel. A ring gear is supported by the differential casing as an assembly and such ring gears are conventionally rotatively driven by an associated pinion gear of a vehicle propeller shaft to provide the casing rotation and differential gear operation.

Normally differential casings are made as castings, but it has also been proposed to make such casings by hot forging or flow forming. The casings are conventionally made as casing halves that are assembled with the differential gearing inside the casings and with the associated ring gears mounted on the casing. Normally such assembly is by threaded connections but laser welding has also been disclosed by the prior art to secure the casing halves to each other.

Prior art references noted during an investigation in connection with the present invention include U.S. Pat. No. 5,533,423 Stehle et al.; U.S. Pat. No. 6,045,479 Victoria et al.; U.S. Pat. No. 6,061,907 Victoria et al.; U.S. Pat. No. 6,146,304 Bendtsen; U.S. Pat. No. 6,176,152 Victoria et al.; U.S. Pat. No. 6,227,024 Koestermeier; U.S. Pat. No. 6,379,277 Victoria et al.; U.S. Pat. No. 6,434,991 Jaschka; U.S. Pat. No. 6,652,408 Rutt et al; U.S. Pat. No. 6,840,883 Orr et al; U.S. Pat. No. 6,945,898 Szuba; U.S. Pat. No. 6,983,632 Mayfield; U.S. Pat. No. 7,207,100 Pascoe et al.; and U.S. Pat. No. 7,261,644 Szuba; and United States Published Patent Applications: US 2006/0276296 Rosochacki et al. and US 2006/0278036 Rosochacki et al.

### SUMMARY OF THE INVENTION

An object of the present invention is to provide an improved vehicle axle differential casing assembly.

In carrying out the above object, one embodiment of a vehicle axle differential casing assembly constructed in accordance with the present invention includes first and second casing halves constructed for assembly to each other about a rotational axis and having hemispherical shapes for receiving a differential gear set. The first casing half includes an axial projection extending from its hemispherical shape and including an annular surface that faces radially outward with respect to the rotational axis. The first casing half also includes a radial flange having a radial outer extremity and an annular surface of a flat shape that faces axially along the rotational axis. The second casing half includes an annular end portion having radially inward and outward facing annular surfaces, with the radially inward facing annular surface contacting the outwardly facing annular surface of the first casing half upon assembly of the casing halves to each other, and with the radially outward facing annular surface of the end portion being located radially inward from the radial outer extremity of the radial flange. The annular end portion of the second casing half also includes oppositely facing axial surfaces one of which contacts the axially facing annular surface of the radial flange of the first casing half upon assembly of the casing halves to each other. An annular ring gear is mounted on the assembled casing halves. This ring gear includes first and second annular axial surfaces, with the first axial surface of the ring gear contacting the axially facing surface of the radial flange of the first casing half radially outward of the end portion of the second casing half upon mounting of the ring gear on the assembled casing halves and with the second axial surface of the ring gear contacting the other axially facing surface of the end portion of the second casing half upon mounting of the ring gear on the assembled casing halves. An annular laser weld connects the first axial surface of the ring gear to the radial outer extremity of the radial flange of the first casing to secure the ring gear to the assembled casing halves and to thereby secure the assembled casing halves to each other.

The first embodiment of the vehicle axle differential casing assembly as disclosed has the axial projection of the first casing half and the end portion of the second half constructed with openings for receiving differential gear pinion shaft ends, and the ring gear has formations for positioning differential gear pinion shaft ends. The ring gear as disclosed also includes an inwardly extending radial flange which contacts the other axially facing surface of the end portion of the second casing half. Furthermore, the first casing half as disclosed is flow formed to provide its hemispherical shape and its axial projection and radial flange.

A second embodiment of a vehicle axle differential casing assembly constructed in accordance with the invention includes a pair of casing halves having partial hemispherical shapes for receiving a differential gear set, and each of the casing halves having a radial outer mounting portion of an annular shape extending about a rotational axis of the casing assembly. An annular ring gear has an inner surface of a partially spherical shape and includes annular mounting portions spaced axially from each other along the rotational axis. A pair of annular laser welds connect the annular mounting portions of the pair of casings to the mounting portions of the annular ring gear to secure the casing halves and ring gear together with the inner surface of the ring gear cooperating with the casing halves to define a generally spherical differential gear set cavity.

The second embodiment of the vehicle axle differential casing assembly disclosed has the ring gear provided with formations for positioning differential gear pinion shaft ends. Also, the mounting portions of the ring gear include a pair of annular notches that respectively receive the annular mounting portions of the pair of casing halves.

A third embodiment of a vehicle axle differential casing assembly constructed in accordance with the invention includes first and second casing halves constructed for assembly to each other about a rotational axis and having hemispherical shapes for receiving a differential gear set. The first casing half includes an axial projection extending from its hemispherical shape and including an annular surface that faces radially outward with respect to the rotational axis. The first casing half also includes a radial flange having a radial outer extremity and an annular surface of a flat shape that faces axially along the rotational axis. The second casing half includes an annular end portion having an annular surface that faces radially inward with respect to the rotational axis to contact the radially outward facing surface of the first casing half projection upon assembly of the casing halves to each other, and the end portion having another annular surface that faces radially outward with respect to the rotational axis. An annular ring gear is mounted on the assembled casing halves and has an annular axially facing surface of a flat shape that contacts annular axially facing flat surface of the radial flange of the first casing half upon mounting of the ring gear on the assembled casing halves. The ring gear also includes an annular surface that faces radially inward and contacts the outwardly facing annular surface of the second casing half end portion upon mounting of the ring gear on the assembled casing halves. First and second laser welds of annular shapes connect the ring gear to the assembled casing halves, with the first annular laser weld securing the ring gear to the radial outer extremity of the radial flange of the first casing half, and the second annular laser weld securing the ring gear to the end portion of the second casing half such that the laser welds secure the casing halves to each other as well as securing the ring gear to the casing halves.

The third embodiment of the vehicle axle differential casing assembly as disclosed has the axial projection of the first casing half and the end portion of the second half provided with aligned openings for receiving differential gear pinion shaft ends, and the ring gear having formations for positioning differential gear pinion shaft ends. The ring gear includes a radial outward annular relief groove adjacent its radially inward facing surface that contacts the outwardly facing annular surface of the the second casing and portion, and the second annular laser weld is located adjacent the radial outward annular relief groove. The first casing half is flow formed to provide its hemispherical shape and its axial projection and radial flange.

### BRIEF DESCRIPTION OF THE DRAWINGS

FIG. 1 is a partial schematic view of a vehicle axle which includes a differential having a housing in which a differential casing assembly according to the invention is mounted for use to provide differential gear action.

FIG. 2 is a sectional view through a first embodiment of a vehicle axle differential casing assembly constructed in accordance with the invention.

FIG. 3 is a half sectional view through a second embodiment of a vehicle axle differential casing assembly constructed in accordance with the invention.

FIG. 4 is a partial half sectional view of the second embodiment but taken at a different angular location about a central rotational axis of the assembly.

FIG. 5 is a half sectional view through a third embodiment of a vehicle axle differential casing assembly constructed in accordance with the invention.

FIG. 6 is a partial view that illustrates the manner in which formations of a ring gear of each embodiment receive a pinion gear shaft end of differential gearing mounted within the casing assembly to provide connection thereof for the differential gear operation.

### DETAILED DESCRIPTION OF THE PREFERRED EMBODIMENTS

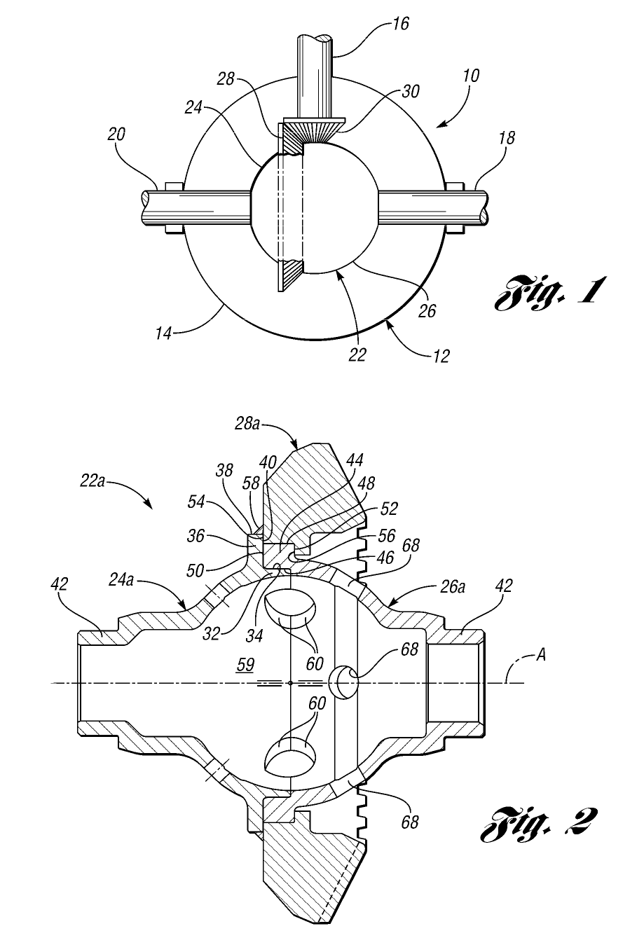

With reference to FIG. 1, a partially and schematically illustrated vehicle axle 10 includes a differential 12 having a housing 14 into which a propeller shaft 16 extends and from which a pair of right and left axle half shafts 18 and 20 extend outwardly for driving associated vehicle wheels. A differential casing assembly 22 is received within the differential housing 14 and is constructed in accordance with the present invention as is hereinafter more fully described. The differential casing assembly 22 includes a casing 24 having a pair of casing halves 24 and 26. An annular ring gear 28 is supported by the casing 24 as is hereinafter more fully described and is rotatively driven by a drive gear 30 on the propeller shaft 16. Differential gearing 31 received within the casing 24 provides driving of the right and left axial half shafts 18 and 20 shown in FIG. 1.

With reference to FIG. 2, a first embodiment of a vehicle axle casing assembly constructed in accordance with the invention is generally indicated by 22a and includes first and second casing halves 24a and 26a constructed for assembly to each other about a rotational axis A and having hemispherical shapes for receiving a differential gear set. The first casing half 24a includes an axial projection 32 of an annular shape extending from its hemispherical shape and including an annular surface 34 that faces radially outward with respect to the rotational axis. The first casing half 24a also includes a radial flange 36 of an annular shape having a radial outer extremity 38 and an annular surface 40 of a flat shape that faces axially along the rotational axis A. The first casing half 24a also includes a journal portion 42 through which the associated axle half shaft extends outwardly from the differential gearing to the associated vehicle wheel. The second casing half 26a includes an annular end portion 44 has radially inward and outward facing annular surfaces 46 and 48. The inwardly facing annular surface 46 contacts the outwardly facing annular surface 34 of the first casing half 24a upon assembly of the casing halves to each other. The outwardly facing annular surface 48 of the end portion 44 is located radially inward from the radial outer extremity 38 of the radial flange 36. The annular end portion 44 of the second casing half also includes oppositely facing axial surfaces 50 and 52. The one axial surface 50 contacts the axial facing annular surface 40 of the radial flange 38 of the first casing half upon assembly of the casing halves to each other. The second casing half 26b like the first casing half 24b has a journal portion 42 from which the associated axle half shaft extends outwardly from the differential gearing to the associated axle half shaft.

An annular ring gear 28a shown in FIG. 2 is mounted on the assembled casing halves 24a and 26a and includes first and second annular axial surfaces 54 and 56. The first axial surface 54 of the ring gear 28a contacts the axial facing surface 40 of the radial flange of the first casing half radially outward of the end portion 44 of the second casing half upon mounting of the ring gear on the assembled casing halves. The second axial surface 56 of the ring gear contacts the other axial facing surface 52 of the end portion 44 of the second casing half upon mounting of the ring gear on the assembled casing halves.

As shown in FIG. 2, the differential casing assembly 22a includes an annular weld 58 that connects the first axial surface 54 of the ring gear to the radial outer extremity 38 of the radial flange 36 of the first casing half to secure the ring gear to the assembled casing halves and to also thereby secure the assembled casing halves to each other within a differential gear cavity 59 defined by the assembled casing.

As disclosed, the first embodiment of the differential casing assembly 22a as shown in FIG. 6 has the axial projection 32 of the first casing half and the end portion 44 of the second casing half constructed with openings 60 for receiving differential pinion shaft ends 62 of the differential gearing 31 received within the assembled casing assembly. Furthermore, the ring gear 28 of each of the embodiments which will be described has formations 64 for positioning each differential gear pinion shaft end 62. In addition, the ring gear 28a shown in FIG. 2 has an inwardly extending radial flange 66 defining the axially facing surface 56 that contacts the second axially facing surface 52 of the end portion 44 of the second casing half. Furthermore, the first casing half 24a may be flow formed from a flat or preformed blank to provide its hemispherical shape and axial projection 32 and radial flange 36. Both the first and second casing halves 24a and 26a also have lubrication openings 68 for permitting oil flow into and out of the casing for lubricating the differential gearing.

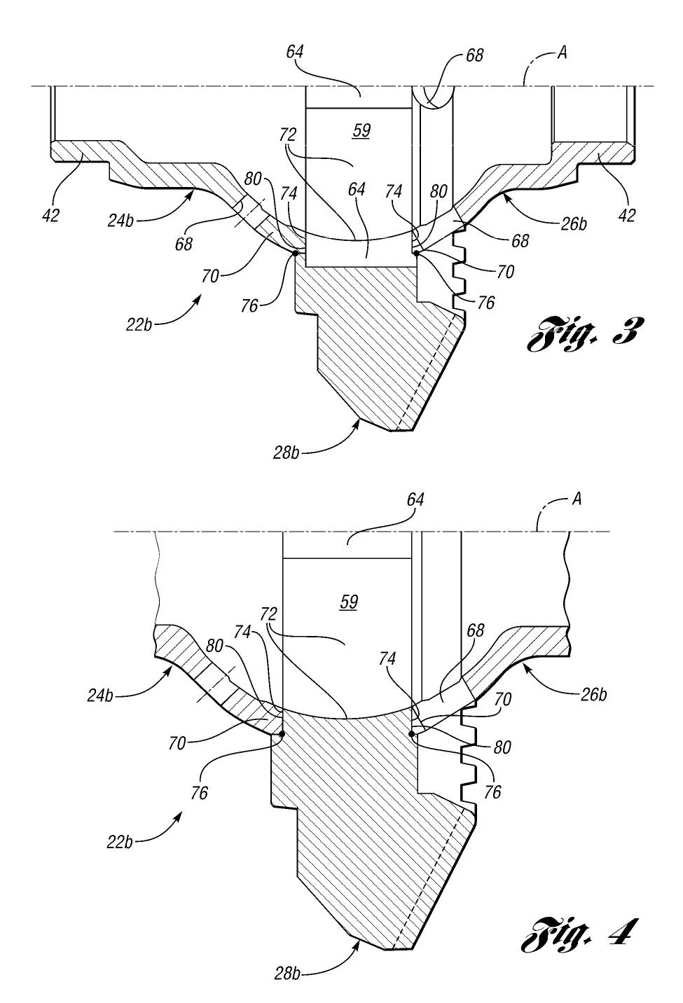

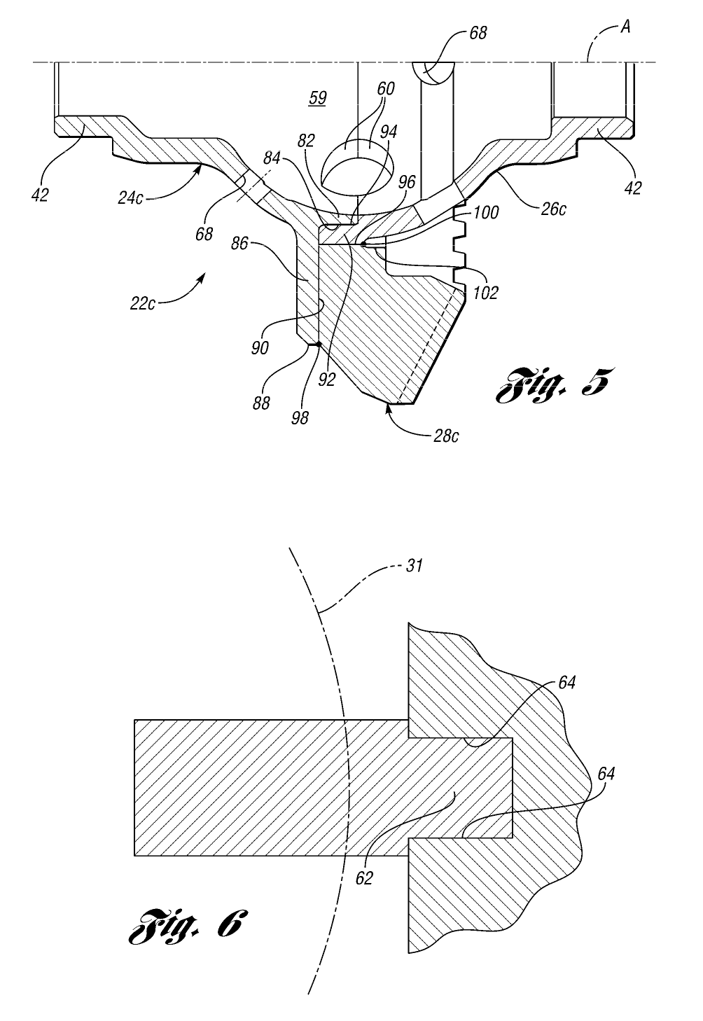

As shown in FIGS. 3 and 4 as well as in FIG. 5, second and third differential casing assembly embodiments 22b and 22c are similar to the previously described differential casing assembly embodiment 22a of FIG. 2 except as will be noted such that like components thereof are identified by like reference numerals and much of the previous description is thus applicable and will thus not be repeated.

With reference to FIG. 3, the second embodiment of a vehicle axle casing assembly constructed in accordance with the present invention is generally indicated by 22b and includes a first casing half 24b and a second casing half 26b for receiving a differential gear set. The pair of casing halves 24a and 26b have partial hemispherical shapes for receiving a differential gear set. Each of the casing halves 24b and 26b has a radial outer mounting portion 70 of an annular shape extending around the central rotational axis A of the casing assembly. An annular ring gear 28b has an inner surface 72 of a partial spherical shape and includes annular mounting portions 74 spaced axially from each other along the rotational axis. A pair of annular laser welds 76 secure the casing halves 24a and 26b and the ring gear 28b together with the inner surface 72 of the ring gear cooperating with the casing halves to define the generally spherical differential gear set cavity 59.

The second embodiment of the vehicle differential casing assembly 22b as shown in FIGS. 3 and 4 has its ring gear 28b provided with the same formations 64 previously discussed in FIG. 6 for connecting the ring gear with pinion shaft ends 62 of the differential gearing. These formations 64 are located in the ring gear at circumferentially spaced positions about the rotational axis A corresponding to the number of pinion shaft ends of the differential gearing, which will normally be three or four. The ring gear 28b shown in FIG. 3 also includes a pair of annular notches 80 that respectively receive the annular mounting portion 74 of the casing halves.

With reference to FIG. 5, the third embodiment of the vehicle axle differential casing assembly constructed in accordance with the invention is generally indicated by 22c and includes first and second casing halves 24c and 26c constructed for assembly to each other about the associated rotational axis A and having hemispherical shapes for receiving a differential gear set. The first casing half 24c includes an axial projection 82 of the annular shape extending from its hemispherical shape and including an annular surface 84 that faces radially outward with respect to the rotational axis A. The first casing half 24c also includes a radial flange 86 of the annular shape having a radial outer extremity 88 and an annular surface 90 of a flat shape that faces axially along the rotational axis A. The second casing half 26c includes an annular end portion 92 having an annular surface 94 that faces radially inward with respect to the rotational axis A to contact the radially outward facing surface 84 of the first casing half projection 82 upon assembly of the casing halves.

A ring gear 28c of the differential casing assembly 22c is mounted on the assembled casing halves 24c and 26c and includes an annular axially facing surface 95 of a flat shape that contacts the annular axially facing flat surface 90 of the radial flange 86 of the first casing half 24c upon mounting of the ring gear on the assembled casing halves. The ring gear 28c also has an annular surface 96 that faces radially inward and contacts the outwardly facing annular surface 94 of the second casing half end portion 92 upon mounting of the ring gear on the assembled casing halves.

With continuing reference to FIG. 5, first and second laser welds 98 and 100 of annular shapes connect the ring gear 28c to the assembled casing halves. More specifically, the first annular laser weld 98 secures the ring gear 28c to the radial outer extremity 88 of the radial flange 86, and the second annular laser weld 100 secures the ring gear 28c to the end portion 92 of the second casing halve 26c such that the laser welds secure the casing halves to each other as well as securing the ring gear to the casing halves.

The third embodiment of the vehicle differential casing assembly 22c as disclosed in FIG. 5 has the axial projection 82 of the first casing half 24c and the end portion 92 of the second casing half 26c provided with aligned openings 60 for receiving the differential gear pinion shaft end 62 as previously discussed in connection with FIG. 6 and the ring gear has formations 64 for positioning the differential gear pinion shaft ends.

As shown in FIG. 5, the ring gear 28c is disclosed as having a radial outer relief groove 102 adjacent its radially inwardly facing surface 96 that contacts the outwardly facing annular surface 94 of the second casing end portion 92, and the second annular laser weld 100 is located adjacent this radial outward annular relief groove. Furthermore, the first casing half 24 is flow formed from either a flat or preformed blank to provide its hemispherical shape and its axial projection 82 and radial flange 86.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle axle differential casing assembly comprising:
first and second casing halves constructed for assembly to each other about a rotational axis and having hemispherical shapes for receiving a differential gear set;
the first casing half including an axial projection extending from its hemispherical shape and including an annular surface that faces radially outward with respect to the rotational axis, and the first casing half also including a radial flange having a radial outer extremity and including an annular surface of a flat shape that faces axially along the rotational axis;
the second casing half including an annular end portion having radially inward and outward facing annular surfaces, the radially inward facing annular surface contacting the outwardly facing annular surface of the first casing half upon assembly of the casing halves to each other and the radially outward facing annular surface of the end portion being located radially inward from the radial outer extremity of the radial flange, the annular end portion also including oppositely facing axial surfaces one of which contacts the axially facing annular surface of the radial flange of the first casing half upon assembly of the casing halves to each other;
an annular ring gear for mounting on the assembled casing halves, the ring gear including first and second annular axial surfaces, the first axial surface of the ring gear contacting the axially facing surface of the radial flange of the first casing half radially outward of the end portion of the second casing half upon mounting of the ring gear on the assembled casing halves and the second axial surface of the ring gear contacting the other axially facing surface of the end portion of the second casing half upon mounting of the ring gear on the assembled casing halves; and
an annular laser weld that connects the first axial surface of the ring gear to the radial outer extremity of the radial flange of the first casing to secure the ring gear to the assembled casing halves and to thereby secure the assembled casing halves to each other.

2. A vehicle axle differential casing assembly as in claim 1 wherein the axial projection of the first casing half and the end portion of the second half have openings for receiving differential gear pinion shaft ends, and the ring gear having formations for positioning differential gear pinion shaft ends.

3. A vehicle axle differential casing assembly as in claim 1 wherein the ring gear includes an inwardly extending radial flange which contacts the other axially facing surface of the end portion of the second casing half.

4. A vehicle axle differential casing assembly as in claim 1 wherein the first casing half is flow formed to provide its hemispherical shape and its axial projection and radial flange.

5. A vehicle axle differential casing assembly comprising:
a pair of casing halves having partial hemispherical shapes for receiving a differential gear set, and each of the casing halves having a radial outer mounting portion of an annular shape extending about a rotational axis of the casing assembly;
an annular ring gear having an inner surface of a partially spherical shape and including annular mounting portions spaced axially from each other along the rotational axis; and
a pair of annular laser welds that connect the annular mounting portions of the pair of casings to the mounting portions of the annular ring gear to secure the casing halves and ring gear together with the inner surface of the ring gear cooperating with the casing halves to define a generally spherical differential gear set cavity.

6. A vehicle axle differential casing assembly as in claim 5 wherein the ring gear includes formations for positioning differential gear pinion shaft ends.

7. A vehicle axle differential casing assembly as in claim 5 wherein the mounting portions of the ring gear include a pair of annular notches that respectively receive the annular mounting portions of the pair of casing halves.

8. A vehicle axle differential casing assembly comprising:
first and second casing halves constructed for assembly to each other about a rotational axis and having hemispherical shapes for receiving a differential gear set;
the first casing half including an axial projection extending from its hemispherical shape and including an annular surface that faces radially outward with respect to the rotational axis, and the first casing half also including a radial flange having a radial outer extremity and an annular surface of a flat shape that faces axially along the rotational axis;
the second casing half including an annular end portion having an annular surface that faces radially inward with respect to the rotational axis to contact the radially outward facing surface of the first casing half upon assembly of the casing halves to each other, and the end portion having another annular surface that faces radially outward with respect to the rotational axis;
an annular ring gear for mounting on the assembled casing halves, the ring gear including an annular axially facing surface of a flat shape that contacts annular axially facing flat surface of the radial flange of the first casing half upon mounting of the ring gear on the assembled casing halves, and the ring gear also including an annular surface that faces radially inward and contacts the outwardly facing annular surface of the second casing half end portion upon mounting of the ring gear on the assembled casing halves; and
first and second laser welds of annular shapes for connecting the ring gear to the assembled casing halves, the first annular laser weld securing the ring gear to the radial outer extremity of the radial flange of the first casing half, and the second annular laser weld securing the ring gear to the end portion of the second casing half such that the laser welds secure the casing halves to each other as well as securing the ring gear to the casing halves.

9. A vehicle axle differential casing assembly as in claim 8 wherein the axial projection of the first casing half and the end portion of the second half have aligned openings for receiving differential gear pinion shaft ends, and the ring gear having formations for positioning differential gear pinion shaft ends.

10. A vehicle axle differential casing assembly as in claim 8 wherein the ring gear includes a radial outward annular relief groove adjacent its radially inward facing surface that contacts the outwardly facing annular surface of the the second casing end portion, and the second annular laser weld being located adjacent the radial outward annular relief groove.

11. A vehicle axle differential casing assembly as in claim 8 wherein the first casing half is flow formed to provide its hemispherical shape and its axial projection and radial flange.
